(19) United States
(12) Patent Application Publication
(10) Pub. No.: US 2006/0231567 A1
(43) Pub. Date: Oct. 19, 2006

(54) Coin operated suntan lotion spray machine

(76) Inventor: John Perrone, Fairfield, NJ (US)

Correspondence Address: Nancy A. Bird, 231 Walton Ave., South Orange, NJ, 07079, US

(21) Appl. No.: 11/104,931

(22) Filed: Apr. 13, 2005

(51) Int. Cl. B67D 5/10

(52) U.S. Cl. 222/2; 604/289

(57) ABSTRACT

An automated sun tan lotion spray booth, which may be used at the beach or pool, without an attendant; and which may offer dispensing of a selection of sun tanning lotions, followed by fan drying; the spray booth may be connected to a dressing booth, which may dispense hair coverings, etc.

### FIELD OF THE INVENTION

The present invention relates to tanning machines and specifically to spray booths for the application of a sunless tanning lotions.

### BACKGROUND OF THE INVENTION

Commercial tanning establishments offer a variety of controlled means for obtaining a tan without going in the sun. These include light tanning booths, and booths for the spray application of sunless tanning solutions. These tanning booths are made available in commercial establishments where one has to pay an employee before being permitted to use the booth. Because of the danger of over to handing in a late tanning booth, control systems have been developed such as the use of tanning cards or tanning coins, which are necessary to operate the booth.

Early examples of spray booths for suntan lotion may be seen in U.S. Pat. Nos. 5,490,192 and 5,664,593, which provide a booth with a mist of suntan lotion, for the body alone, the neck and head of the user extending outside the booth.

Examples of sunless spray tanning booths can be seen in U.S. Pat. Nos. 5,922,333, and 6,199,557. U.S. Pat. No. 5,363,347 illustrates a light tanning booth with two slots; one for paying, and one for safety. The payment slot is said to accept coins or bills. However, the booth is not activated by the insertion of coins or bills. Because of the dangers inherent in over-use of a light tanning booth, the booth may only be activated after insertion of a “safety” card which monitors the user's use of the booth.

Vend a Tan machines, a vending machine for containers of a variety of commercial sun tanning and/or sunscreen lotions are available in many resort areas.

It is an object of the present invention to provide a spray booth for the application of suntan lotion and or sunscreen on a self-vending basis.

Is an object of the present invention to provide an outdoor self-vending spray booth for the application of suntan lotion in an outdoor setting, such as by the side of the pool; and at remote locations, such as at the beach

Is a further object of the present invention to provide a spray booth for the application of suntan/sunscreen lotions, which allows the user to select among a variety of lotions offered.

### SUMMARY OF THE INVENTION

These objects, as well as other objects which will become apparent from the discussion that follows, are achieved, in accordance with the present invention, which comprises a coin operated suntan lotion straying booth, having an enclosure which may be constructed of at least one curved wall, two walls for a passageway, or four walls; at least one access door in a wall of the spray booth, at least one spray nozzle in at least one wall, a ceiling, and a floor. Preferably, the floor has a drain. The spray booth has a supply of at least one suntan lotion, and a pump, connected to said at least one spray nozzle, and coin operated means to actuate the pump, pumping the sun tan lotion to, and through, the at least one nozzle, to spray the suntan lotion. The coin operated means may in fact be a slot for receiving a coin, bill, credit card, etc. The spray of suntan lotion is metered by volume or by time of spraying, to release one dose during each actuation. The booth may also have a supply of other suntan lotions and sun blocks, and means for selecting which sun tan/sun block is sprayed. A supply of a cleaning solution may also be connected to the pump, for spraying the cleaning solution to, and through the nozzles, to the ceiling, walls and floor, after spraying the metered dose of suntan lotion. To accommodate sun tan lotions, sun block and cleaning solutions of various viscosities, the nozzle opening is adjustable, to achieve an appropriate spraying action regardless of the viscosity.

The booth may also have a dressing room, with its own door, as well as the interconnecting door to the booth. When the booth has a dressing room, preferably, a “coin” must be placed in the slot before one can gain access to the dressing booth. The spray nozzles may be timed to start at a certain time period after insertion of the coins, or, another mechanism, such as a motion detector in the spray booth, or the closing of the door between the dressing booth and the spray booth, may begin the spraying action. It is preferred that the spray booth have an array of multiple nozzles for spraying suntan lotion. The dressing booth or spray booth may have a storage cabinet for stowing those objects one does not want sprayed, and a dispensing cabinet, for, e.g., hair protectors or bathing suit protectors.

For a full understanding of the present invention, reference should now be made to the following detailed description of the preferred embodiments of the invention as illustrated in the accompanying drawings.

### BRIEF DESCRIPTION OF THE DRAWINGS

FIG. 1 illustrates a semi-permanent enclosure for a suntan lotion spray booth according to the present invention.

FIG. 2 illustrates an all-weather, alternative, enclosure for the sun tan lotion spray booth according to the present invention.

FIG. 3 illustrates an all-weather, alternative, enclosure for the sun tan lotion spray booth with an attached dressing/undressing enclosure.

FIG. 4 illustrates an all-weather sun tan lotion enclosure according to the present invention, with a sun tan lotions recovery system.

### DETAILED DESCRIPTION OF THE INVENTION

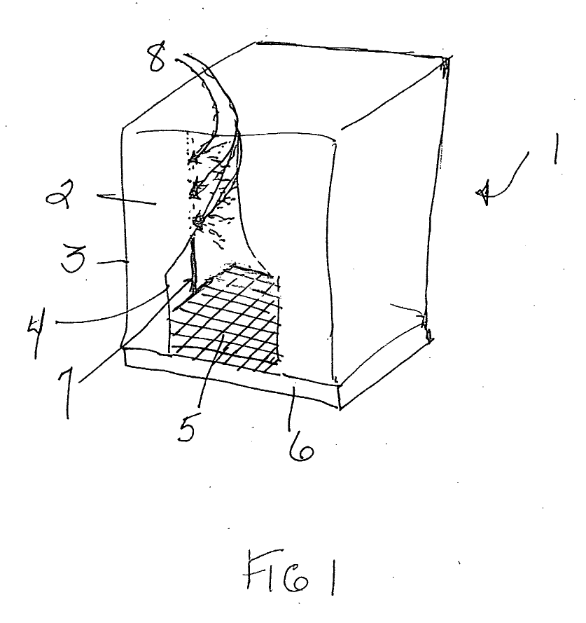

The preferred embodiments of the present invention will now be described with reference to FIGS. 1-4 of the drawings. Identical elements in the various Figures are designated with the same reference numerals.

The present invention comprises a booth, or an enclosure, containing spray nozzles for applying suntan/sun block lotion to the body of the user. The booth is controlled by a “coin” operated activation system, which is installed directly on, or adjacent, the booth. In this application, “coin” operated system includes systems for accepting payment in coins, tokens, debit or credit cards, including hotel room card-keys, or hotel services tokens or cards. Insertion of the “coins” activates the spray booth. The booth may thus be self-vending, requiring no machine operator to turn it on. The booth may also operate as a self-vending machine for various suntan lotions, permitting the user to select the suntan lotion to be sprayed.

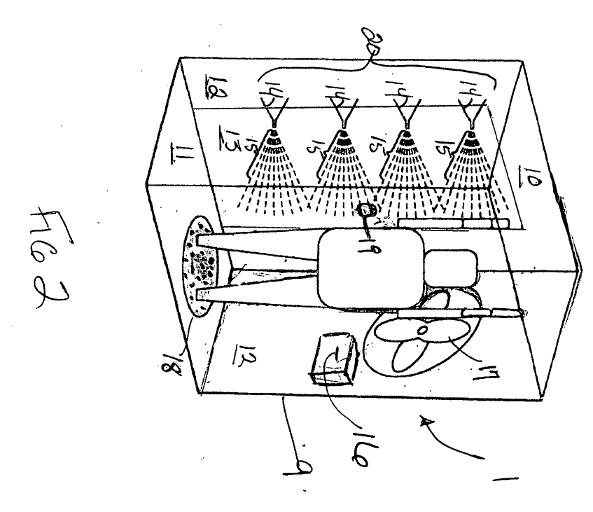

FIG. 1 illustrates a spray booth, 1, comprising a semi-permanent enclosure, 2, which may be made of a tent type structure, 3, erected above a drainage floor. In this embodiment of the invention the drainage floor comprises a grid, 5, atop a fluid impervious tray, 6. The tray may be connected to a drainage system, or be a stand alone system requiring intermittent cleaning. Instead of a grid, sand or small stones maybe placed in the keep the feet of the user above the suntan lotion and/or cleaning solution. The cleaning solution will be described below in relation to FIG. 2. In alternative embodiments, the tent type structure may be set up over a beach-type floor of sand or small stones, with its own drainage system, or which is frequently cleaned, as with products used for cleaning oil spills, or changed, like kitty litter.

Within the enclosure are vertical pipes, 7, which support spray heads, 8, and may also supply them with the suntan lotion to be dispensed. These vertical pipes may also be part of the pole system for the tent. The use of the enclosure ensures that the suntan lotion will not be sprayed indiscriminately in the air, allowing for generous spraying action, while limiting any cleanup required. In this semi-permanent enclosure, the walls may be made of canvas, woven mesh, heavy cotton fabric such as that used for shower curtain, or plastic sheeting. This material is temporarily or permanently secured to the poles of the tent to form the enclosure. The walls of the tent structure may be disposable, with a new one used every season.

The permanent elements of the spray booth of FIG. 1 are the vertical pipes supporting the spray heads, and the pipes or tubing from which the suntan lotion is brought to the spray-heads, and the coin operated activation system. There is no limit to the number of vertical pipes which may rise from the sides and/or corners of a rectangular floor. The floor grid and tray, may be cleaned and reused, and temporarily or permanently connected to drainage pipes. There is no limit on the shape of the tray and grid, there being no preference between an oval, rectangular or other shape, for the grid and/or tray. The door, or opening for this semi-permanent enclosure may simply be the flap of the tent, or overlapping vertical strips, which separated to allow a person to enter, and then re-close.

Attached to the vertical pipes (or the poles of the tent), is a coin operated system. Insertion of the “coins” activates the spray system, which brings a suntan lotion from a storage tank (not shown) and pumps it to, and through, the spray heads. Also fastened to the vertical pipes, or the poles of the tent, may be a simple dispensing mechanism (not shown), as simple as a Ziploc plastic bag, containing, e.g., shower caps and/or protective coverings for a swimsuit. Fluid impervious containers for stowing a bathing suit, hat, sunglasses, wallet or sunglasses may also be fastened to the vertical pipes, or the poles of the tent.

In another alternative spray booth, where the sun tan lotion is complementary, the coin operated system may be replaced by motion detector. Such a system can be set up as a passageway between, e.g., a locker room, and a sun area such as a beach. In this embodiment, only two walls are necessary. Regarding the number of walls for a spray booth, it should be noted that one curved wall that forms and enclosure, such as a circular or oval wall, may be used in the sun tan lotion spray booth of the present invention.

FIG. 2 illustrates a suntan lotion spray booth comprising an all weather enclosure, 9. The enclosure can be made from any liquid impervious material, such as molded fiberglass, plastic, sheet-metal, etc. These suntan lotion spray booths may be set out at the beach, unattended, for use by anyone with the “coin”s required. It is within the purview of this invention that the “coin” operated actuating system for the spray booth include a mechanism for giving change, and accepting a charge card, from a credit card company, or a hotel.

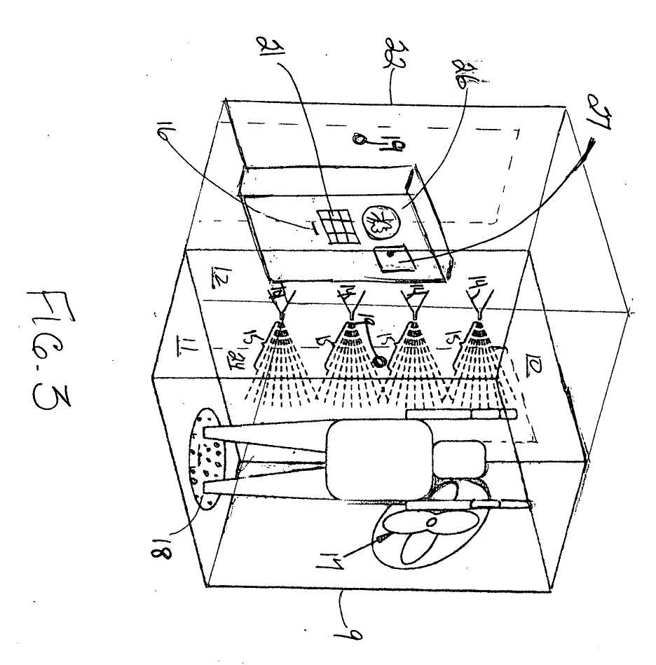

As shown in FIG. 2 the all weather enclosure, 9, has a ceiling, 10, a floor, 11, walls, 12, and a door, 13. Secured to at least one of the walls, is at least one spray nozzle, 14, for dispensing a spray, 15, of suntan lotion, after insertion of monetary means, in the slot, 16. In a preferred embodiment the spray booth comprises an array, 20, of spray nozzles. The booth may indeed contain more than one array of spray nozzles. In another preferred embodiment, the enclosure includes arrays on each wall. The booth may also contain a drying fan, 17, located in a wall, or ceiling of the enclosure. Not shown in FIG. 2 are the means for selecting a particular suntan lotion from a choice of suntan lotions, an example of which means is shown in FIG. 3. Also not shown, is means for selecting actuation of only a portion of the array of nozzles, as when the booth with be used by a small adult or child. If required, the spray nozzles, 14, may be provided with a means for adjusting the nozzle for dispensing a spray or mist of suntan lotions of various viscosity.

The exterior of the enclosure of sun tan lotion spray booth of the present invention may be provided with advertising, applied directly to the enclosure, slid between groove supplied for various sized advertising posters and/or boards, or placed in clear pockets provided for advertising posters and/or boards. In addition, the exterior and/or interior walls of the enclosure may provide instruction on how to use the spray booth. The instruction may be in text, pictures, audio and/or video tape.

Insertion of monetary means releases a metered dose of suntan lotion. The dose may be metered by volume or by time of spraying. After dispensing the suntan lotion, the booth may be self-cleaning, such as by means of a spray system for a cleaning solution, dispensed after each dose of suntan lotion. A drain, 18, located in the floor may be provided for drainage of excess suntan lotion, and cleaning solution. The nozzles for dispensing the cleaning solution may be separate from the spray nozzles for suntan lotion, or the cleaning solution may be dispensed through the same nozzles as the suntan lotion, cleaning the nozzles as well as the enclosure after dispensing each dose of sun tan booth. The cleaning solution may be water, with or without surfactants detergents, or solvent.

According to the present invention, the selection of sun tan lotions provided may include sun block. If desired, sun block of varying strength may be separately selected, and may be dispensed separately or combined and sprayed with the selected sun tan lotion. If the user desires, two or more doses of a variety of sun tan products may be dispensed.

As shown in FIG. 3, the suntan lotion spray booth may be provided with an adjacent dressing booth, 22, with a door, 24, between the dressing booth and the suntan lotion spray booth. As shown in FIG. 3 the dressing booth, 22, may be provided with a dispensing cabinet, such as that shown at 26, comprising a box with a flexible, slotted, front panel; such as used in tissue dispensers, for dispensing e.g., shower caps, towels, and protective sheaths for bathing suits. In fact this dispensing cabinet may be located within the spray booth, or on the exterior of the enclosure.

Also shown in FIG. 3 is a storage cabinet, 27, for stowing one's bathing suit, sunglasses, wallet, footwear, etc. before entering the spray booth. However, if the spray booth is cleaned between uses, the storage cabinet may just as easily be located within the walls of the spray booth. The storage cabinet comprises no particular structure, just walls and a door, sufficient to maintain garments and/or valuables away from the spray of the suntan lotion. The simplest storage cabinet may resemble a locker with a door that opens out. Alternatively, the storage cabinet may comprise a boxlike structure with a horizontally hinged swinging, and self-closing door.

FIG. 3 also illustrates a means for selecting the particular suntan lotion desired, in this illustration a series of push buttons, 21. If desired, advertising for, e.g., the various sun tan lotions offered, may be secured on or adjacent the buttons. This structure may also be located within the spray booth. As shown in FIG. 3 the slot, 16, for inserting coins, bills or cards is located in the dressing booth. There is no requirement that the slot be located in the dressing booth and in fact the slot may be located on the exterior of the booth, or within the spray booth enclosure itself.

In a preferred embodiment, slots 16 for “coins” are located outside the enclosure with spray nozzles, and insertion of “coins” allows the user to turn open the door to the spray booth, as with handle, 19. (Alternatively, the “coin” may permit the user to open the exterior door to the dressing room.) Also in a preferred embodiment, after making a lotion selection, closing the door to the spray booth actives the spray nozzles after a brief delay, such as 10 seconds. In another preferred embodiment, motion sensors in the spray booth may actuate the spray nozzles, if and only if, “coins” have been recently deposited

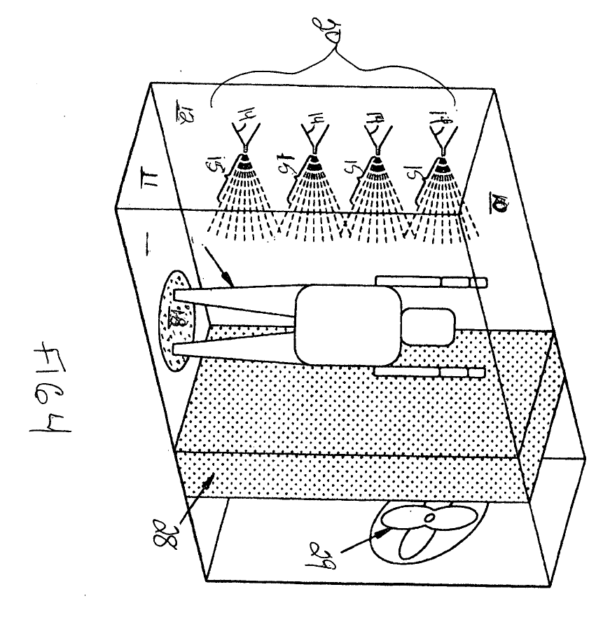

FIG. 4 illustrates a still preferred embodiment of the suntan lotion spray booth of the present invention, wherein the spray booth is provided with a recovery system or filter, 28, in an upright wall, with an exhaust fan, 29, located behind the filter. Such a system serves to clear the air of the spray booth, making it easier to breathe; while at the same time pulling the excess of suntan lotion into an upright filter. By applying a solvent, such as water, to the top of the filter, the suntan lotion may be washed out of the filter and recovered, re-circulated, and reused if desired.

Thus the present invention provides a machine for applying suntan lotion in a vending machine format in a liquid tight enclosure generally upright shape. The machine can be controlled by a coin operated or bill system installed on or next to the machine. As no operator is required, the machines may be left unattended, this machine could be located at the beach, boardwalks, hotels, resorts other sun tanning areas to provide a way of dispensing sun tan lotion by spraying it evenly on the body of the person in a convenient and inexpensive manner.

The machine may have 5 or more buttons that will advertise the lotions that are sold, as well as permitting the user to select the desired lotion. The Machine will preferably have array of spray nozzles in at least one wall. The nozzles will adjust to the thickness of lotion chosen. The suntan lotion spray nozzles are appropriately located and mounted in the inner walls of the machine. A pump pumps the lotion from a dispenser to the nozzles. As the lotion is pumped through the nozzle, it is formed into mist droplets. The mist sprays the body of the person in the machine in that manner.

The machine may be made to withstand the outdoors in any weather, providing the user with a choice of sun tam lotion at the insertion of the coin or bill. The machine will then spray a mist of the lotion that they chose, evenly, onto their body. After that, a fan may be provided to dry the lotion on their body. To facilitate the fan drying, and because the suntan lotion will be applied by means of a spray or mist, known brands of suntan lotion may be reformulated for the spray booth. For instance, suntan lotions intended to be applied by hand contain lotions which make it easier to evenly spread the sun tanning ingredient across the skin. Less of these lotion-type ingredients may be needed when applying the sun tanning ingredients by spray nozzles. Those sun tan “lotions” currently sold in spray bottles have already been reformulated for spray application, and would require little or no reformulation to be used in the sun tan lotion spray booths of the present invention.

In an alternative structure for use between a dressing room and a sun area, the spray booth may be constructed as a tent passageway, and operated, not by the insertion of coins, but by motion detectors which sense a person walking through the tent passageway, and apply a dose of sun tanning lotion. The passageway may have a sign at the beginning, explaining the automation spray application of sun tan lotions, and permitting a selection of lotions by those going from dressing room to sun area.

There has thus been shown and described a novel sun tan lotion spray booth which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

I claim:

1. A coin operated suntan lotion straying booth, comprising:
a) an enclosure comprising at least one wall, at least one door in a wall, a ceiling, a floor with a drain, and at least one spray nozzle in at least one wall,
b) a supply of at least one suntan lotion, at said at least one spray nozzle,
c) coin operated means for actuating a pump, to pump the sun tan lotion to, and through, the at least one nozzle, to spray the suntan lotion, said means comprising at least one slot for a coin.

2. A coin operated suntan lotion spray booth as in claim 1, wherein the supply of suntan lotion to the nozzles is metered, releasing one dose during each actuation.

3. A coin operated suntan lotion spray booth as in claim 1, further comprising a supply of another suntan lotion, said pump pumping said another sun tan lotion to, and through said at least one spray nozzle.

4. The coin operated booth of claim 1, further comprising a supply of cleaning solution connected to the pump, for spraying the cleaning solution to, and through the nozzles, to the ceiling, walls and floor, after spraying the metered dose of suntan lotion.

5. A coin operated suntan lotion spray booth as in claim 6, wherein the suntan lotion nozzle opening is adjustable, to spray the cleaning solution.

6. A coin operated sun tan lotion spray booth of claim 6, wherein the nozzle opening is adjustable to spray sun tan lotions of different viscosity

7. A method for operating a suntan lotion spray booth as in claim 6, comprising spraying one lotion through the nozzles, adjusting the nozzles for spraying a cleaning solution, and spraying cleaning solution through the nozzles.

8. The method of claim 7, further comprising selecting one suntan lotion to be sprayed.

9. A method for operating a suntan lotion spray booth as in claim 6, comprising spraying one lotion through the nozzles, adjusting the nozzles for spraying another suntan lotion, and spraying said another suntan lotion.

10. The coin operated spray booth of claim 1, further comprising an array of multiple nozzles for spraying suntan lotion.

11. The coin operated spray booth as in claim 1, further comprising four walls, and an array of nozzles on four walls of the booth.

12. The coin operated suntan lotion spray booth of claim 1, further comprising a dressing booth, with a door between the dressing booth and the spray booth.

13. The coin operated suntan lotion spray booth as in claim 12, wherein the dressing booth further comprises a storage cabinet.

14. The coin operated suntan lotion spray booth as in claim 12, wherein the spray booth further comprises a dispensing cabinet.

15. The coin operated suntan lotion spray booth as in claim 12, wherein the dressing booth further comprises a storage cabinet.

16. The coin operated suntan lotion spray booth as in claim 1, wherein the spray booth further comprises a storage cabinet.

17. The coin operated suntan lotion spray booth as in claim 1, wherein the spray booth further comprises a dispensing cabinet.

18. The coin operated sun tan lotion spray booth as in claim 1, having one circular wall.

19. A walk-through, sun tan lotion spray passageway between a locker room and a sun exposure area, said passageway comprising two walls, nozzles provided at a wall, for spraying suntan lotion when actuated by a motion detector.

20. A walk-through, sun tan lotion spray passageway as in claim 19, further more than one sun tan lotion supplied to the nozzles, and means for selecting among the sun tan lotions provided.

21. A The coin operated sun tan lotion spray booth as in claim 10, further comprising means for selecting actuation of the lower portion of the array of nozzles.
